(19) United States
(12) Patent Application Publication
(10) Pub. No.: US 2026/0161983 A1
(43) Pub. Date: Jun. 11, 2026

(54) MULTI-AGENT CAUSAL DISCOVERY

(71) Applicant: NEC Laboratories America, Inc., Princeton, NJ (US)

(72) Inventors: Zhengzhang Chen, Princeton Junction, NJ (US); Haifeng Chen, West Windsor, NJ (US)

(21) Appl. No.: 19/413,308

(22) Filed: Dec. 9, 2025

Related U.S. Application Data
(60) Provisional application No. 63/730,621, filed on Dec. 11, 2024.

(51) Int. Cl. G06N 7/01; G06N 3/042; G06N 5/045

(52) U.S. Cl. CPC G06N 7/01; G06N 3/042; G06N 5/045

(57) ABSTRACT

Systems and methods for multi-agent causal discovery. In an embodiment, the system and method may include generating an initial causal graph, prompting a first AI agent to generate contextual data using metadata from the initial causal graph, prompting a second AI agent to generate causal constraints using the initial causal graph and the generated contextual data, wherein the second AI agent includes a prompt builder, and generating a refined causal graph using the generated causal constraints.

### RELATED APPLICATION INFORMATION

This application claims priority to U.S. Provisional Application No. 63/730,621, filed on December 11, 2024, incorporated herein by reference in its entirety.

### BACKGROUND

### Technical Field

The present invention relates to agent causal discovery. More particularly, the present invention pertains to multi-agent causal discovery augmented by contextual data.

### Description of the Related Art

Identifying cause-and-effect relationships in complex systems is important for a variety of applications. For example, applications include neuralgia diagnosis in medicine, protein pathway analysis in computational biology, and root cause locating in microservice architectures. The process of discovering such relationships from observational data, known as causal discovery. Large language models (LLMs) have the reasoning ability to infer meaningful causal relationships. Agent-based systems can leverage LLMs to perform causal discovery.

### SUMMARY

According to an aspect of the present invention, a method for multi-agent causal discovery is provided for, the method comprising generating an initial causal graph, prompting a first artificial intelligence (AI) agent to generate contextual data using metadata from the initial causal graph, prompting a second AI agent to generate causal constraints using the initial causal graph and the generated contextual data, wherein the second AI agent includes a prompt builder, wherein generating causal constraints includes generating a prompt, by the prompt builder, using the initial causal graph and the generated contextual data, generating an explanation, by a knowledge large language model (LLM), for each non-existing causal relationship in the initial causal graph based on the prompt, and generating at least one conclusion, by a constraint LLM, for each generated explanation, and generating a refined causal graph using the generated causal constraints.

According to another aspect of the present invention, a system is provided for multi-agent causal discovery, the system comprising a processor, and a memory storing computer-readable instructions that, when executed by the processor, cause the system to generate an initial causal graph, prompt a first artificial intelligence (AI) agent to generate contextual data using metadata from the initial causal graph, prompt a second AI agent to generate causal constraints using the initial causal graph and the generated contextual data, wherein the second AI agent includes a prompt builder, wherein the instructions to generate causal constraints include generate a prompt, by the prompt builder, using the initial causal graph and the generated contextual data, generate an explanation, by a knowledge large language model (LLM), for each non-existing causal relationship in the initial causal graph based on the prompt, and generate at least one conclusion, by a constraint LLM, for each generated explanation, and generate a refined causal graph using the generated causal constraints.

According to another aspect of the present invention, a computer program product is provided for multi-agent causal discovery, the computer program product comprising a non-transitory computer-readable storage medium containing computer program code, the computer program code when executed by one or more processors causes the one or more processors to perform operations, the computer program code comprising instructions to generate an initial causal graph, prompt a first artificial intelligence (AI) agent to generate contextual data using metadata from the initial causal graph, prompt a second AI agent to generate causal constraints using the initial causal graph and the generated contextual data, wherein the second AI agent includes a prompt builder, wherein the instructions to generate causal constraints include generate a prompt, by the prompt builder, using the initial causal graph and the generated contextual data, generate an explanation, by a knowledge large language model (LLM), for each non-existing causal relationship in the initial causal graph based on the prompt, and generate at least one conclusion, by a constraint LLM, for each generated explanation, and generate a refined causal graph using the generated causal constraints.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system and method for multi-agent causal discovery, in accordance with an embodiment of the present invention;

FIG. 2 is a diagram illustrating a practical application of multi-agent causal discovery in disease treatment and vehicle accidents, in accordance with an embodiment of the present invention;

FIG. 3 is a block/flow diagram illustrating a system and method for multi-agent causal discovery, in accordance with an embodiment of the present invention;

FIG. 4 is a diagram illustrating a data augmentation agent, in accordance with an embodiment of the present invention;

FIG. 5 is a diagram illustrating a toolkit used for retrieving metadata, in accordance with an embodiment of the present invention;

FIG. 6 is a diagram illustrating a causal constraint agent, in accordance with an embodiment of the present invention;

FIG. 7 is a diagram illustrating a prompt, in accordance with an embodiment of the present invention;

FIG. 8 is a block/flow diagram illustrating a system for multi-agent causal discovery, in accordance with an embodiment of the present invention;

FIG. 9 is a block/flow diagram illustrating a method for multi-agent causal discovery, in accordance with an embodiment of the present invention;

FIG. 10 is a block/flow diagram illustrating an iterative subprocess, in accordance with an embodiment of the present invention; and

FIG. 11 is a block/flow diagram illustrating a method executed by the causal constraint agent, in accordance with an embodiment of the present invention.

### DETAILED DESCRIPTION OF PREFERRED EMBODIMENTS

In accordance with embodiments of the present invention, systems and methods are provided to and for multi-agent causal discovery.

The present invention relates to a multi-agent system for causal discovery. As previously mentioned, Agent-based systems can leverage large language models (LLMs) for causal discovery because LLMs can infer meaningful causal relationships. However, a single-agent system is prone to hallucination. The present invention improves on the single-agent system by using multiple agents to perform causal discovery. For example, the present invention has a causal constraint agent handling causal discovery and a data-augmentation agent to provide contextual information to further avoid hallucinations.

Furthermore, commonsense and domain knowledge are invaluable for identifying cause-and-effect relationships among semantically meaningful variables. Thus, the present invention further improves causal discovery by integrating common sense and domain knowledge into the causal discovery process. The present invention accomplishes this via the data-augmentation agent retrieving relevant external information and having the causal constraint agent integrate the retrieved information into the causal discovery process.

In one embodiment, a system and method is provided for multi-agent causal discovery, the system and method comprising generating an initial causal graph, prompting a first artificial intelligence (AI) agent to generate contextual data using metadata from the initial causal graph, prompting a second AI agent to generate causal constraints using the initial causal graph and the generated contextual data, wherein the second AI agent includes a prompt builder, wherein generating causal constraints includes generating a prompt, by the prompt builder, using the initial causal graph and the generated contextual data, generating an explanation, by a knowledge large language model (LLM), for each non-existing causal relationship in the initial causal graph based on the prompt, and generating at least one conclusion, by a constraint LLM, for each generated explanation, and generating a refined causal graph using the generated causal constraints.

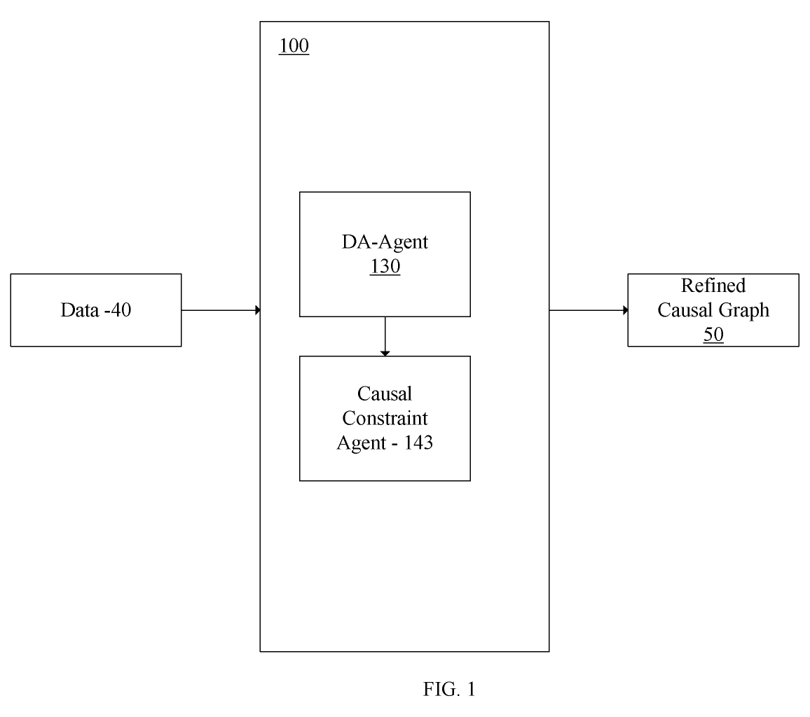

Referring now in detail to the figures in which like numerals represent the same or similar elements and initially to FIG. 1, a high-level system and method 100 for multi-agent causal discovery is illustratively depicted in accordance with one embodiment of the present invention. Data 40 is sent to the system and method 100 to be processed. The system and method 100 can enhance causal discovery by integrating multi-modal data and leveraging the reasoning capabilities of multiple tool-augmented agents. The system and method 100 may use external knowledge from logs, metrics, and other contextual data sources to refine and validate causal graphs. The system and method 100 can have a multi-agent setup including a data augmentation (DA) agent 130 and a causal constraint agent 143. By using multiple agents, there is a benefit of reduced hallucinations. The DA-agent 130 can retrieve contextual information by retrieving information relevant to the data 40 from external sources. The DA-agent 130 then sends the contextual information to the causal constraint agent 143. The causal constraint agent 143 integrates the contextual information with the data 40. The system and method 100 then generate a refined causal graph 50. The refined causal graph 50 is refined as a result of the integration of contextual data retrieved by the DA-agent 130. One benefit is that the refined causal graph 50 improves understanding and management of complex systems. For example, the refined causal graph 50 facilitates better understanding of disease diagnosis, personalized medicine, predictive modeling, and real-time root cause analysis in dynamic environments.

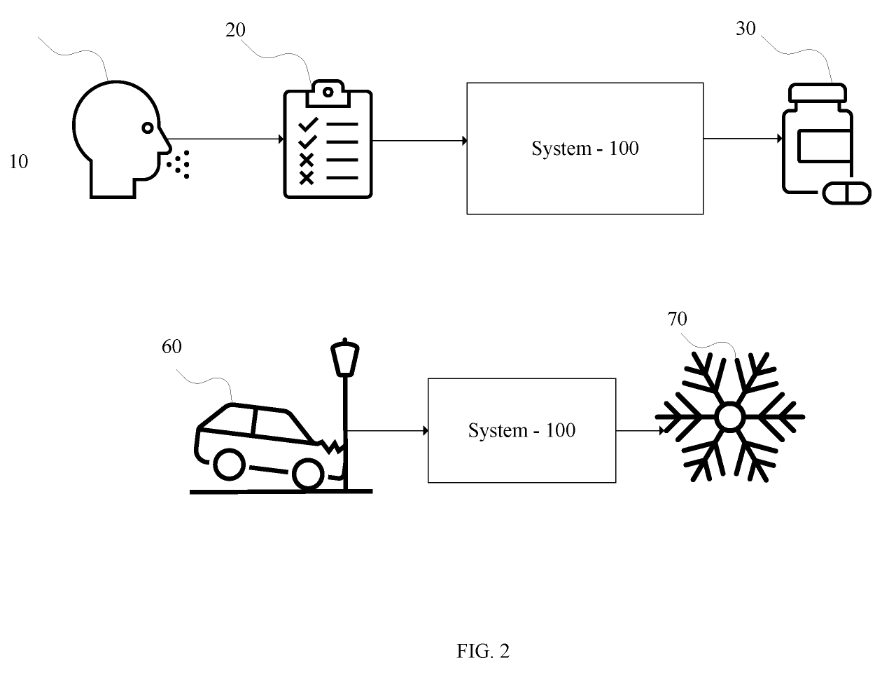

Referring to FIG. 2, a practical application of the system and method 100 is diagnosing diseases and recommending medications. In FIG. 2, an individual 10 is sick and notes 20 of the symptoms in the form of observational data are taken about the individual 10. The notes 20 are then sent to the system and method 100. The system and method 100 retrieves contextual data based on the notes 20 and integrates the contextual data into the causal discovery process. Through the context integrated causal discovery process, the system and method 100 can discover the causation of the symptoms and prescribes a medication regimen 30 based on the diagnosis.

Continuing with FIG. 2, a practical application of the system and method 100 is identifying the cause of vehicle accidents. The system and method 100 receive observational data 60 in the form of the crash scene and environment. The system and method 100 retrieves contextual information on the observational data 60 and integrates the contextual information into the causal discovery process. Through the context integrated causal discovery process, the system and method 100 can discover the causation of vehicle crash which is snow 70.

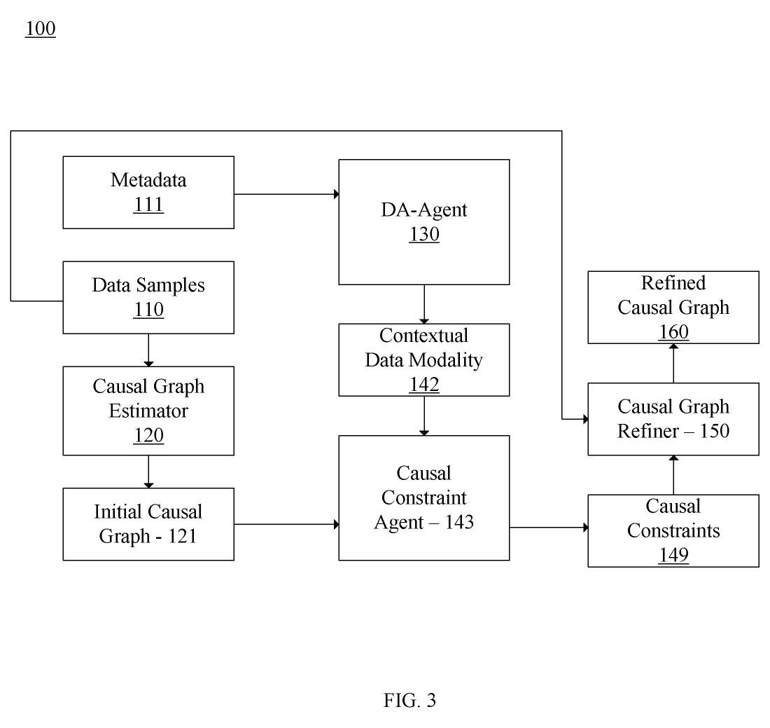

Referring to FIG. 3, a system and method 100 for multi-agent causal discovery is disclosed. The multi-agent system and method 100 is an improvement in causal discovery because by using multiple agents (DA-agent 130 and casual constraint agent 143) to facilitate the causal discovery, the chances of hallucination go down.

In block 110, data samples are obtained. The data samples are separated from metadata by role. The data samples can be raw observational data. The sources of data samples can include numerical metrics, textual logs, and other contextual information. For example, in operational systems, data samples can consist of key performance indicators (KPIs) such as latency, throughput, CPU/memory usage, and log data including Kubernetes pod-level events or error messages. In healthcare, the data samples can include biomarkers, diagnostic records, and patient histories.

Having a diverse data collection can be beneficial because the diversity establishes the foundation for identifying causal relationships among variables. Each variable can represent a system entity or observable phenomenon whose interactions can underpin useful insights. By collecting comprehensive data across modalities, the system and method 100 can ensure that no relevant information is overlooked.

The data samples can be sent to a causal graph estimator 120. The causal graph estimator 120 can use statistical causal discovery (SCD) algorithms to generate an initial causal graph. The SCD algorithms analyze the collected observational data to infer potential causal relationships. Potential SCD algorithms can include Peter-Clark (PC) algorithm, extra search (ES), and DirectLiNGAM (Linear Non-Gaussian Acyclic Model). In block 121, the causal graph estimator 120 generates the initial causal graph and sends the initial causal graph to the causal constraint agent 143. The initial causal graph can be a directed acyclic graph.

The system and method 100 can enhance the initial causal graph generated in block 121. To enhance the initial casual graph, the system and method 100 can retrieve contextual data by providing a DA-agent 130 with metadata of the initial causal graph. In block 111, the DA-agent 130 obtains the metadata of the initial causal graph. The DA-agent 130 can then use the metadata to retrieve contextual data. The DA-agent 130 can access external information sources, such as web application programming interfaces (APIs), domain-specific databases, or log repositories, to enrich the understanding of the variables in the initial causal graph and their relationships. For example, in a healthcare application, the DA-agent 130 can retrieve detailed descriptions of biomarkers from medical literature or clinical databases. In operational systems, the DA-agent 130 can access and retrieve logs detailing recent failures or performance anomalies. The DA-agent 130 can then de-format and summarize the retrieved logs.

The DA-agent 130 can use an iterative search process to retrieve the contextual data. Each iteration can refine the query based on prior results, avoiding redundancy and maximizing relevance. The DA-agent 130 can then summarize the retrieved data and structure the summarized data into at least three categories. These categories can be a detailed description of the dataset, individual explanations for each variable, and insights into potential relationships between any pair of variables. In block 142, the DA-agent 130 generates contextual data modality and sends the contextual data modality to the causal constraint agent 143. The contextual data modality can be the structured summaries based on the retrieved metadata. The contextual data modality can be the contextual data that will be integrated into the initial causal graph.

In an embodiment, the DA-agent 130 can use a single round search to obtain metadata.

A causal constraint agent 143 receives the contextual data modality from the DA-agent 130 and the initial causal graph from the causal graph estimator 120. The causal constraint agent 143 leverages reasoning techniques, combining enriched data with pre-trained knowledge embedded in LLMs. The causal constraint agent 143 can access a distinct LLM to integrate the contextual data modality with the initial causal graph. The LLM can reason about the existence or absence of each causal relationship in the initial causal graph, providing explanations based on both retrieved data and its internal knowledge.

The causal constraint agent 143 can access another distinct LLM. This LLM evaluates the conclusions from the previous LLM, validating the reasoning process. The causal constraint agent 143 can then employ confidence scoring techniques, such as Top-K Guess reasoning, to quantify the reliability of the assessments of the LLMs. The causal constraint agent 143 can then generate a set of validated causal relationships supported by robust semantic reasoning. These validated relationships can later guide the restricting of the initial causal graph. In block 149, the causal constraint agent 143 generates causal constraints. The causal constraints can be a constraint matrix encoded with the validated relationships. The constraint matrix can serve as a formal representation of the refined causal insights. Each entry in the matrix indicates the presence or absence of a causal link between variables, as determined by the reasoning process. The constraint matrix can enable the subsequent application of SCD algorithms to incorporate these constraints systematically.

The causal graph refiner 150 can receive the causal constraints and generate a refined causal graph. The causal graph refiner 150 can reuse the same SCD algorithm used by the causal graph estimator 120 to generate the initial causal graph. By rerunning the SCD algorithm, the refined causal graph can remain as a directed acyclic graph while incorporating the causal constraints. In block 160, the causal graph refiner 150 generates the refined causal graph. The generated refined causal graph can both be statistically and semantically enriched, offering a more accurate representation of causal relationships.

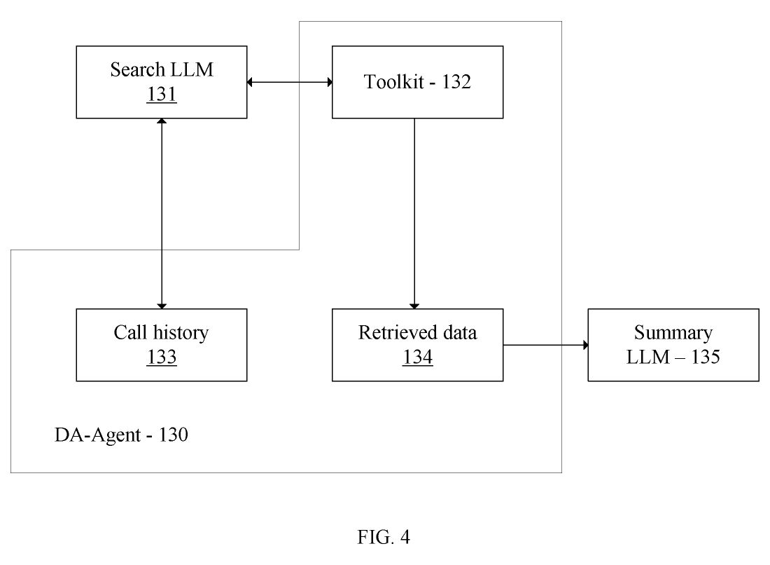

Referring to FIG. 4, the DA-agent 130 can provide contextual data to the causal constraint agent by accessing and using two LLMs. One of the LLMs is a search LLM 131. The search LLM 131 can receive the metadata about the initial causal graph. Upon receiving the metadata, the search LLM 131 will check a call history 133 to determine if a new call is needed. If a new call is needed, the search LLM 131 will make a call to a toolkit 132 to retrieve data. After making the call, the search LLM 131 will add the call to the call history 133.

The search LLM 131 can iteratively make calls to the toolkit 132 to retrieve data. Then after each iterative call, the search LLM 131 stores the call in the call history 133. After storing the call, the search LLM 131 will check the comprehensiveness of the call history 133. If the comprehensiveness of the call history 133 has met a threshold, then the search LLM 131 can end making iterative calls to the toolkit 132. In an embodiment, the threshold can be a minimum threshold. The search LLM 131 can determine the comprehensiveness of the call history by being prompted with a query. For example, the query can be “is a query needed?” One benefit of the iterative search is that that iterative search does not have issues with biased queries and has less difficulty in producing comprehensive augmented data. Another benefit is that there is an improvement in retrieving relevant and comprehensive data. This improvement is beneficial in domains where variable-specific information is challenging to locate such as medicine.

In block 134, the toolkit 132 sends the retrieved data summaries to a summary LLM 135. In an embodiment, the summary LLM 135 can divide the retrieved data summaries into indexed document chunks. This is beneficial because the size of the retrieved data summaries from iterative searches can exceed the summary LLM’s 135 context window. Then the summary LLM 135 can use a Retrieval-Augmented Generation (RAG) framework to generate a final summary.

In an embodiment, the summary LLM can use a log framework to generate a summary.

The summary LLM 135 can summarize the retrieved data summaries into a final summary. This way the information is condensed enough to be integrated later by the causal constraint agent. In an embodiment, the summary LLM 135 summarizes the retrieved data summaries into at least three types of cues: (1) description of the dataset; (2) description of each variable in the graph; and (3) relationships between the variables. This final summary can serve as the contextual data modality that will be sent to the causal constraint agent.

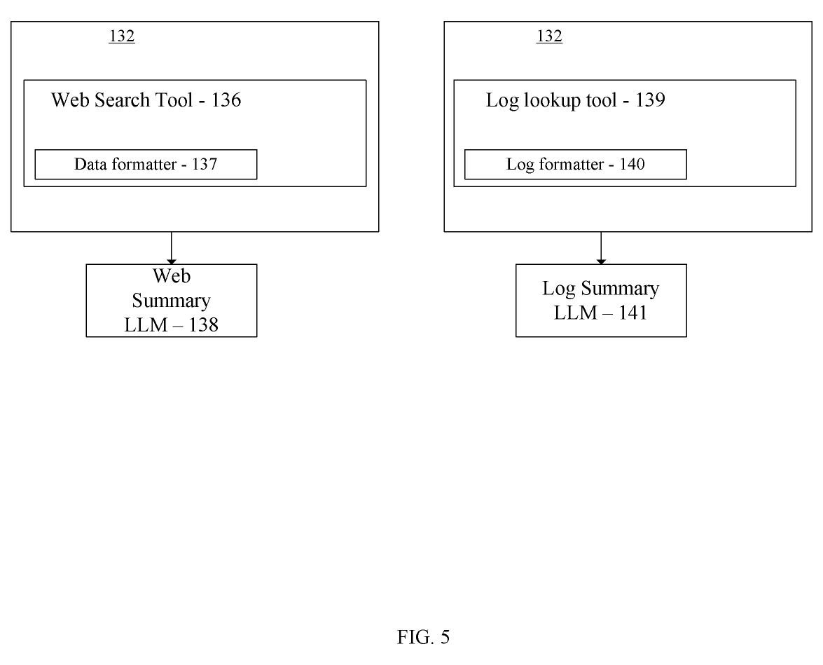

Referring to FIG. 5, the toolkit 132 can use tools to retrieve data. The tools can summarize the retrieved data. The toolkit 132 can include a web search tool 136. The web search tool 136 can use search APIs such as Google® search API. The web search tool 136 can generate a search query for the search API to retrieve webpages. The web search tool 136 can use a Top-K ranking algorithm to determine the top webpages from the retrieved webpages. The web search tool 136 can include a data formatter 137. The data formatter 137 de-formats the webpages. For example, the data formatter 137 strips the HTML tags from the webpages and turns the webpages into plain documents. The web search tool 136 can access a web-summary LLM 138. The web-summary LLM 138 can summarize the de-formatted webpages into concise summaries.

The toolkit 132 can also include a log lookup tool 139. The log lookup tool 139 can be used for applications where a domain-specific database is available such as the process logs in root cause analysis for microservice systems. The log lookup tool 139 can use exact lookup. For example, the log lookup tool 139 uses the variable name as the keyword, and thus the corresponding log can be retrieved directly. The log lookup tool 139 can include a log formatter 140 and access a log summary LLM 141. The log formatter 140 can de-format the retrieved logs. For example, the log formatter 140 can remove the log templates. The log summary LLM 141 can then summarize the de-formatted logs.

In an embodiment, the toolkit 132 can further include application-specific tools such as Wikipedia API and code lookup APIs.

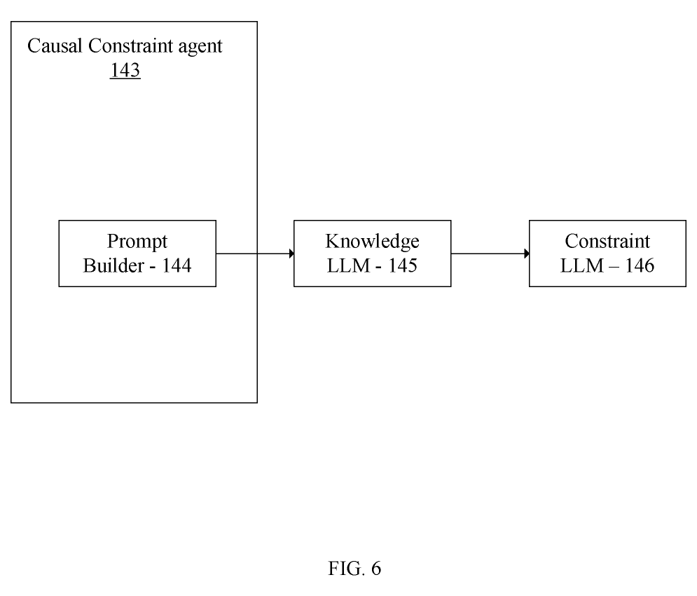

Referring to FIG. 6, the causal constraint agent 143 generates causal constraints using the initial causal graph from the causal graph estimator and the contextual data modalities from the DA-agent. Thus, the causal constraint agent 143 integrates the contextual data from the DA-agent into the initial causal graph. This enhances the initial causal graph with contextual information and provides a deeper understanding of the relationships in the initial causal graph.

The causal constraint agent 143 can include a prompt builder 144 and access a distinct knowledge LLM 145 and a distinct constraint LLM 146. By having a distinct knowledge LLM 145 and a distinct constraint LLM 146, the causal constraint agent 143 can perform more accurately. The prompt builder 144 can generate a prompt that integrates the initial causal graph with contextual data modalities from the DA-agent 130 to prompt the knowledge LLM 145. The knowledge LLM 145 can be tasked with explaining each (non-)existing causal relationship in the initial causal graph based on the contextual data modalities and the knowledge LLM’s 145 own knowledge. These explanations from the knowledge LLM 145 can either support or refute the causal relationships in the initial causal graph. The explanations are then used to prompt the constraint LLM 146 to draw at least one conclusion on the existence of each relationship behind the explanation. The conclusion drawn can be a yes or no. The causal constraint agent 143 can validate each conclusion by eliciting verbal confidence from the constraint LLM 146 using a Top-K guesses algorithm. For example, the causal constraint agent 143 can prompt the constraint LLM 146 to output multiple candidate conclusions per explanation and each candidate conclusion has an explicit verbal confidence indicator. The causal constraint agent 143 then selects the candidate conclusion with the highest stated verbal confidence as the final constraint for that explanation.

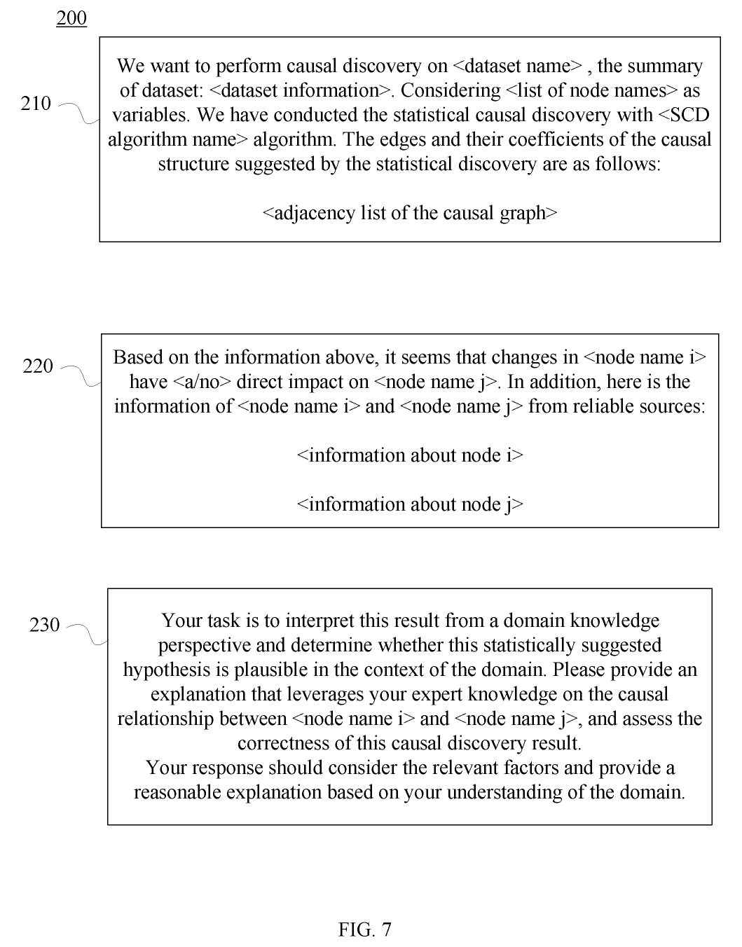

Referring to FIG. 7, an illustrative example of a prompt 200 that can be generated by the prompt builder to prompt the knowledge LLM is shown. The prompt 200 can include, for example, three parts. The first part 210 can provide, for example, the knowledge LLM with the prerequisite initial causal graph. In this example, the first part 210 provides the initial causal graph in the form of an adjacency list.

The second part 220 can include, for example, the contextual data modalities from the DA-Agent and introduces the variables to be looked at. The second part 220 can also include a hypothesis about the relationship between the two nodes and gives background information on the nodes via contextual data modalities. In this example, the nodes are “node name i" and “node name j”.

The third part 230 can include, for example, the prompt for the knowledge LLM. In this example, the prompt is a task to interpret a result from a domain knowledge perspective and determine the plausibility of the hypothesis in the second part 220. The third part 230 can further include a prompt for an explanation from the knowledge LLM based on their knowledge base and assessment of the correctness of the result. The third part 230 can also include further details about how the response should be formulated. For example, the explanation has to be reasonable.

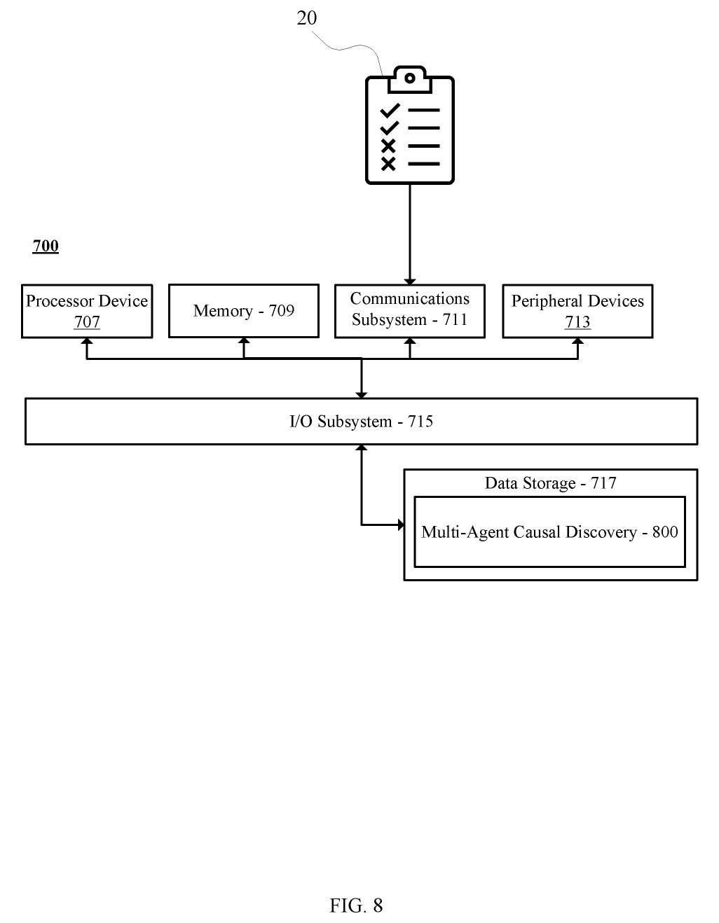

FIG. 8 refers to a block diagram of a computer system for multi-agent causal discovery, in accordance with an embodiment of the present invention. The block diagram illustrates the implementation of the multi-agent causal discovery in a computer system context. In an embodiment, a computing device 700 can be implemented as the method 100. The computing device 700 illustratively includes the processor device 707, the input/output (I/O) subsystem 715, the memory 709, the data storage device 717, and the communications subsystem 711, and/or other components and devices commonly found in a server or similar computing device. The computing device 700 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 709, or portions thereof, may be incorporated in the processor device 707 in some embodiments.

The processor device 707 may be embodied as any type of processor capable of performing the functions described herein. The processor device 707 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 709 may be embodied as any type of volatile or non-volatile memory or data storage capable of performing the functions described herein. In operation, the memory 709 may store various data and software employed during operation of the computing device 700, such as operating systems, applications, programs, libraries, and drivers. The memory 709 is communicatively coupled to the processor device 707 via the I/O subsystem 715, which may be embodied as circuitry and/or components to facilitate input/output operations with the processor device 707, the memory 709, and other components of the computing device 700. For example, the I/O subsystem 715 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 715 may form a portion of a system-on-a-chip (SOC) and be incorporated, along with the processor device 707, the memory 709, and other components of the computing device 700, on a single integrated circuit chip.

The data storage device 717 may be embodied as any type of device or devices configured for short-term or long-term storage of data such as, for example, memory devices and circuits, memory cards, hard disk drives, solid state drives, or other data storage devices. The data storage device 717 can store program code for multi-agent causal discovery 800. Any or all of these program code blocks may be included in a given computing system.

The communications subsystem 711 of the computing device 700 may be embodied as any network interface controller or other communication circuit, device, or collection thereof, capable of enabling communications between the computing device 700 and other remote devices over a network. The communications subsystem 711 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 700 may also include one or more peripheral devices 713. The peripheral devices 713 may include any number of additional input/output devices, interface devices, and/or other peripheral devices. For example, in some embodiments, the peripheral devices 713 may include a display, touch screen, graphics circuitry, keyboard, mouse, speaker system, microphone, network interface, and/or other input/output devices, interface devices, GPS, camera, and/or other peripheral devices. The peripheral devices 713 can also be used to enter data samples 20 into the I/O subsystem 715.

Of course, the computing device 700 may also include other elements (not shown), as readily contemplated by one of skill in the art, as well as omit certain elements. For example, various other sensors, input devices, and/or output devices can be included in computing device 700, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 700 are readily contemplated by one of ordinary skill in the art given the teachings of the present invention provided herein.

The computing device 700 may be coupled to receive data samples 20. For example, the computing device 700 may be coupled to a cloud server to receive data samples 20. The computing device 700 may be coupled to the cloud server through communications subsystem 711.

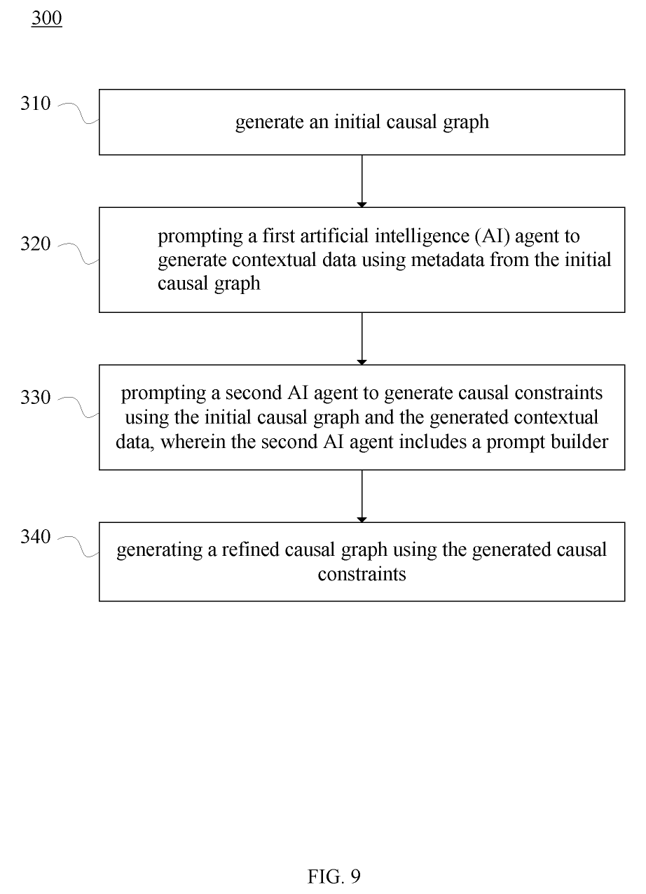

Referring to FIG. 9, a flowchart illustrating a system and method for multi-agent causal discovery 300. The system and method 300 can have a block 310 for generating an initial causal graph. The initial causal graph can be generated based on observational data and using a statistical causal discovery (SCD) algorithm. The initial causal graph can be a directed acyclic graph.

Then in block 320, the first AI agent can be prompted to generate contextual data using metadata from the first initial causal graph. The first AI agent can accomplish this by accessing a search LLM to retrieve the contextual data. The search LLM can retrieve the data by accessing a toolkit. The toolkit can include a web search tool and a log lookup tool. The search LLM can summarize the retrieved data. The first AI agent can further access a summary LLM. The summary LLM can further summarize the retrieved data summaries into a final summary. The summary LLM can divide the retrieved data summaries into indexed document chunks. The summary LLM 135 can summarize the retrieved data summaries into at least three types of cues: (1) description of the dataset; (2) description of each variable in the graph; and (3) relationships between the variables. The first AI agent can retrieve the contextual data iteratively or in a single round.

In block 330, the second AI agent can be prompted to use the initial causal graph and the generated contextual data to generate causal constraints. The second AI agent can include a prompt builder and can access distinct LLMs to integrate the generated contextual data with the initial causal graph. The prompt builder can generate a prompt using the initial causal graph and the generated contextual data. Then using the prompt, a distinct knowledge LLM can generate an explanation for each non-existing causal relationship in the initial causal graph. Using the explanations, a distinct constraint LLM can generate at least one conclusion for each explanation. In block 340, a refined causal graph is generated using the generated causal constraints. The refined causal graph can be generated using the same algorithm as the initial causal graph. For example, both could be generated using an SCD algorithm and both can be a directed acyclic graph.

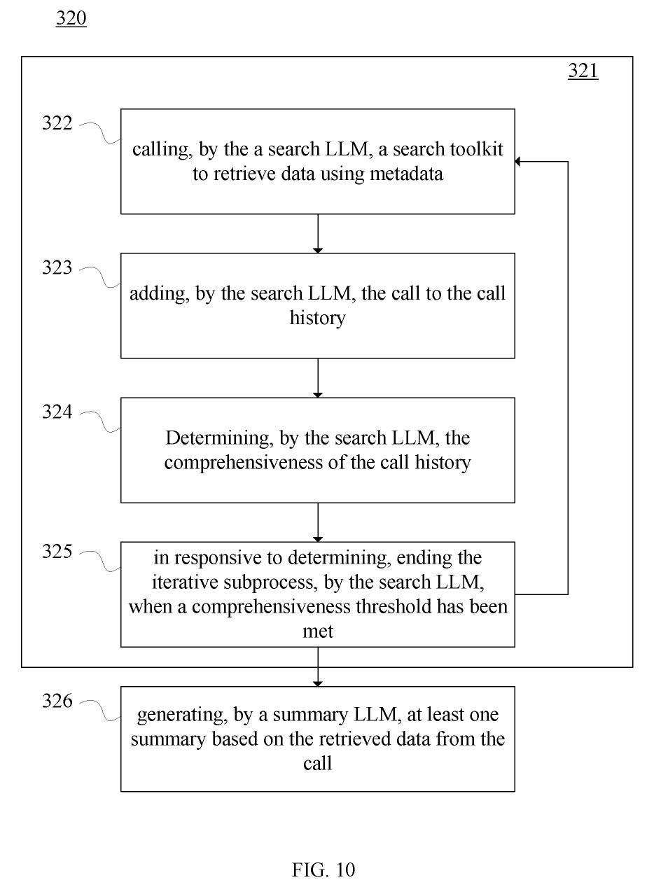

FIG. 10 describes an embodiment of block 320. Block 320 can include an iterative subprocess 321 for searching with metadata and a block 326 for generating, by a summary LLM, at least one summary based on the retrieved data from the call. The summaries generated in block 326 can be the contextual data modalities generated by the first AI agent. The summary can include, for example, three categories of information. Those categories can include a detailed description of the dataset, individual explanations for each variable, and insights into potential relationships between variables.

The iterative subprocess 321 can include a block 322 for calling, by a search LLM, a search toolkit to retrieve data using metadata if the new call is not repetitive according to the call history. The search toolkit can include a web search tool and a log lookup tool. Both tools can use APIs. The search toolkit via the tools can retrieve data, de-format the data, and summarize retrieved data from each call.

In block 323, the search LLM can add the call to the call history. The call history keeps track of the calls to prevent redundancy.

In block 324, the search LLM, can determine the comprehensiveness of the call history. If the search LLM determines the comprehensiveness has met a threshold, the search LLM can terminate the iterative process. The search LLM can determine the comprehensiveness of the call history with a prompt. For example, the prompt can be “is a query needed?” The comprehensiveness of the call history can be a minimum threshold.

In block 325, if the search LLM determines that the comprehensiveness of the call history has met a threshold, then the search LLM terminates the iterative subprocess 321. Otherwise, the iterative subprocess 321 is repeated beginning with block 322.

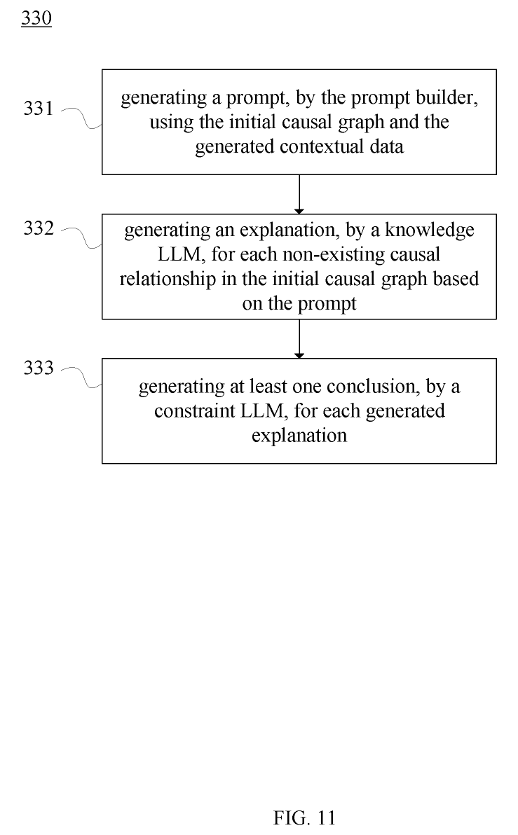

Referring to FIG. 11, the block 330 for generating a causal constraint can further include accessing distinct LLMs (a knowledge LLM and a constraint LLM). In block 331, a prompt builder can generate a prompt for the knowledge LLM using the initial causal graph and generated contextual data. In block 332, the knowledge LLM, which is distinct from the constraint LLM, can generate an explanation for each non-existing causal relationship in the initial causal graph based on the prompt. In block 333, the constraint LLM, can generate at least one conclusion for each generated explanation. The conclusion can be a yes or a no. In an embodiment, the constraint LLM can validate the verbal confidence of a conclusion using Top-K guess algorithm. For example, the constraint LLM can be prompted to generate multiple candidate conclusions with each candidate conclusion having a verbal confidence indicator. The candidate conclusion with the highest verbal confidence is selected as the final constraint for that explanation.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

Embodiments described herein may be entirely hardware, entirely software or including both hardware and software elements. In a preferred embodiment, the present invention is implemented in software, which includes but is not limited to firmware, resident software, microcode, etc.

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for multi-agent causal discovery, the method comprising:
generating an initial causal graph;
prompting a first artificial intelligence (AI) agent to generate contextual data using metadata from the initial causal graph;
prompting a second AI agent to generate causal constraints using the initial causal graph and the generated contextual data, wherein the second AI agent includes a prompt builder, wherein generating causal constraints includes:
generating a prompt, by the prompt builder, using the initial causal graph and the generated contextual data;
generating an explanation, by a knowledge large language model (LLM), for each non-existing causal relationship in the initial causal graph based on the prompt; and
generating at least one conclusion, by a constraint LLM, for each generated explanation; and
generating a refined causal graph using the generated causal constraints.

2. The method of claim 1, wherein generating contextual data includes:
a subprocess for searching with metadata including:
calling, by a search LLM, a search toolkit to retrieve data using metadata; and
adding, by the search LLM, the call to a call history; and
generating, by a summary LLM, at least one summary based on the retrieved data from the call.

3. The method of claim 2, wherein the search toolkit includes a web search tool and a log lookup tool.

4. The method of claim 2, wherein the subprocess includes:
determining the comprehensiveness of the call history; and
in responsive to determining, ending the subprocess when a comprehensiveness threshold has been met.

5. The method of claim 4, wherein the subprocess is iterative.

6. The method of claim 2, wherein the at least one summary includes a description of a dataset, description of each variable in a graph, and relationships between any pair of variables.

7. The method of claim 1, wherein generating causal constraints further includes:
selecting the conclusion from the at least one conclusion with the highest verbal confidence as a final constraint for the explanation.

8. The method of claim 1, wherein the initial causal graph is a directed acyclic graph.

9. A system for multi-agent causal discovery comprising:
a processor; and
a memory storing computer-readable instructions that, when executed by the processor, cause the system to:
generate an initial causal graph;
prompt a first artificial intelligence (AI) agent to generate contextual data using metadata from the initial causal graph;
prompt a second AI agent to generate causal constraints using the initial causal graph and the generated contextual data, wherein the second AI agent includes a prompt builder, wherein the instructions to generate causal constraints include:
generate a prompt, by the prompt builder, using the initial causal graph and the generated contextual data;
generate an explanation, by a knowledge large language model (LLM), for each non-existing causal relationship in the initial causal graph based on the prompt; and
generate at least one conclusion, by a constraint LLM, for each generated explanation; and
generate a refined causal graph using the generated causal constraints.

10. The system of claim 9, wherein the instructions for generating contextual data includes:
a subprocess for searching with metadata including:
call, by a search LLM, a search toolkit to retrieve data using metadata; and
add, by the search LLM, the call to a call history; and
generate, by a summary LLM, at least one summary based on the retrieved data from the call.

11. The system of claim 10, wherein the search toolkit includes a web search tool and a log lookup tool.

12. The system of claim 10, wherein the subprocess further includes:
determine the comprehensiveness of the call history; and
in responsive to determine, end the subprocess when a comprehensiveness threshold has been met.

13. The system of claim 12, wherein the subprocess is iterative.

14. The system of claim 9, wherein the instructions to generate causal constraints further includes:
select the conclusion from the at least one conclusion with the highest verbal confidence as a final constraint for the explanation.

15. The system of claim 9, wherein the initial causal graph is a directed acyclic graph.

16. A computer program product comprising a non-transitory computer-readable storage medium containing computer program code, the computer program code when executed by one or more processors causes the one or more processors to perform operations, the computer program code comprising instructions to:
generate an initial causal graph;
prompt a first artificial intelligence (AI) agent to generate contextual data using metadata from the initial causal graph;
prompt a second AI agent to generate causal constraints using the initial causal graph and the generated contextual data, wherein the second AI agent includes a prompt builder, wherein the instructions to generate causal constraints include:
generate a prompt, by the prompt builder, using the initial causal graph and the generated contextual data;
generate an explanation, by a knowledge large language model (LLM), for each non-existing causal relationship in the initial causal graph based on the prompt; and
generate at least one conclusion, by a constraint LLM, for each generated explanation; and
generate a refined causal graph using the generated causal constraints.

17. The computer program product of claim 16, wherein the instructions for generating contextual data includes:
a subprocess for searching with metadata including:
call, by a search LLM, a search toolkit to retrieve data using metadata; and
add, by the search LLM, the call to a call history; and
generate, by a summary LLM, at least one summary based on the retrieved data from the call.

18. The computer program product of claim 17, wherein the subprocess includes:
determine the comprehensiveness of the call history; and
in responsive to determine, end the subprocess when a comprehensiveness threshold has been met.

19. The computer program product of claim 18, wherein the subprocess is iterative.

20. The computer program product of claim 16, wherein the instructions to generate causal constraints further includes:
select the conclusion from the at least one conclusion with the highest verbal confidence as a final constraint for the explanation.
